(19) United States
(12) Patent Application Publication
(10) Pub. No.: US 2008/0216754 A1
(43) Pub. Date: Sep. 11, 2008

(54) RAISED DOG FOOD BOWL WITH INTEGRATED FOOD STORAGE

(76) Inventors: Vance A. Lorenzana, Oswego, IL (US); Moises B. Lorenzana, Plainfield, IL (US)

Correspondence Address: WELSH & KATZ, LTD, 120 S RIVERSIDE PLAZA, 22ND FLOOR, CHICAGO, IL, 60606, US

(21) Appl. No.: 12/042,183

(22) Filed: Mar. 4, 2008

Related U.S. Application Data
(60) Provisional application No. 60/893,452, filed on Mar. 7, 2007.

(51) Int. Cl. A01K 5/01

(52) U.S. Cl. 119/61.55; 119/61.5; 119/61.56

(57) ABSTRACT

An animal feeder includes a storage region having a bottom wall, and sidewalls extending upwards from the bottom wall. The animal feeder further comprises a cover with at least one depression in the cover to receive a feeding bowl. The cover forms an airtight with the storage region. The feeding bowl is isolated from the storage region when it is seated in the depression.

### CROSS-REFERENCE TO RELATED APPLICATION

This application claims the benefit of the filing date of U.S. Provisional Application Ser. No. 60/893,452 filed Mar. 7, 2007 and entitled “Raised Dog Food Bowl with Integrated Food Storage”, the entire contents of which are incorporated herein by reference.

### FIELD OF THE INVENTION

The present invention generally relates to the field of animal feeders and, more particularly, to raised dog food bowls for taller dogs, having a food storage compartment.

### BACKGROUND OF THE INVENTION

Veterinarians recommend a raised bowl for taller dogs. Many digestive problems in dogs are caused by taller dogs having to bend their head down to eat or drink. A raised bowl provides an ergonomically correct eating position for taller dogs. This elevated feeding position also alleviates pain for dogs suffering from arthritis.

While there are structures known in the prior art which provide an elevated feeding position, these structures have significant disadvantages. The disadvantages include animal feeders whose food storage containers are not sealed airtight from the surrounding environment. This lack of proper sealing exposes the stored food to bacterial contaminants, which results in a loss of freshness.

Additionally, feeders known in the prior art are also disadvantaged in that the food storage compartments are not completely sealed off from the food bowl. Users of these feeders run the risk of accidentally spilling food or water into the food storage compartment when they refill the food bowl.

Thus there is a need to provide an animal feeder that elevates the feeding bowl, provides an airtight food storage compartment and completely seals off the food bowl from the food storage compartment.

### SUMMARY OF THE INVENTION

Embodiments of the present invention generally provide a raised animal feeder with an integrated food storage container which seals airtight.

### BRIEF DESCRIPTION OF THE DRAWINGS

FIG. 1 is a perspective view of the elevated dog food bowl according to a preferred embodiment of the present invention;

FIG. 2 is a top view of the elevated dog food bowl;

FIG. 3 is a side view of the elevated dog food bowl;

FIG. 4 is another side view of the elevated dog food bowl;

FIG. 5 is a bottom view of the elevated dog food bowl;

FIG. 6 is a cross-sectional view of the elevated dog food bow;

FIG. 7 is a perspective view of the cover for the elevated dog food bowl;

FIG. 8 is a partial enlarged view of a sealing mechanism; and

FIG. 9 is an exploded perspective view of the elevated dog feed bowl.

### DETAILED DESCRIPTION OF THE PREFERRED EMBODIMENT

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

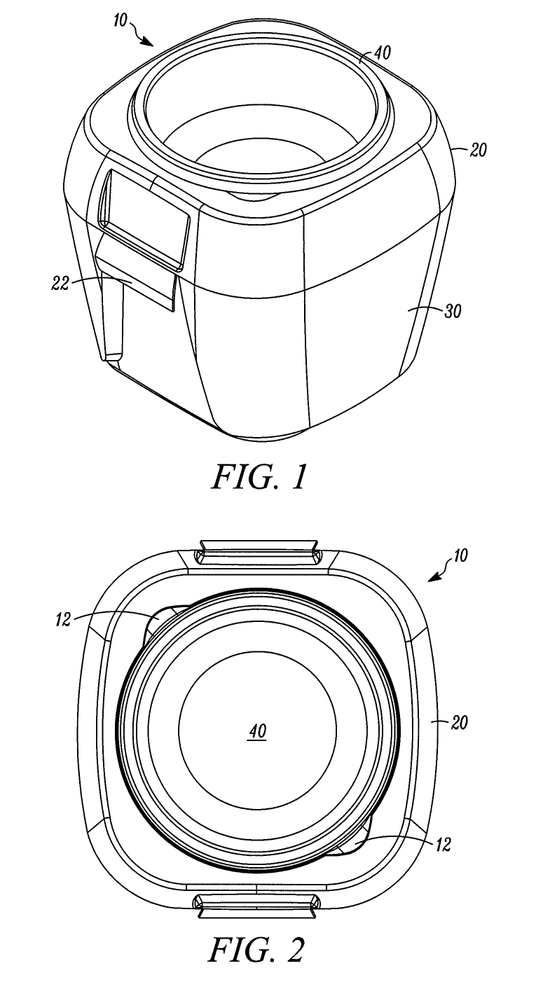

FIG. 1 is a perspective view of the elevated dog food bowl 10 having an integrated storage region 32, which can be best seen in FIG. 6. A base 30 forms the storage region 32 and can hold multiple items such as dog food. A cover 20 can be positioned on top of the base 30. Latches 22 on the cover 20 releasably lock the cover 20 to the base 30 to provide an airtight seal between the cover 20 and the base 30.

FIG. 2 is a top view of the elevated dog food bowl 10. A container 40 is shown sitting within a depression 14. The container 40 is removable from the cover 20 to enable a user to clean and refill it without having to expose the food storage compartment 32 in the base 30. Indentations 12 in the cover 20 aid in removal of the container 40 when it is seated within the depression 14.

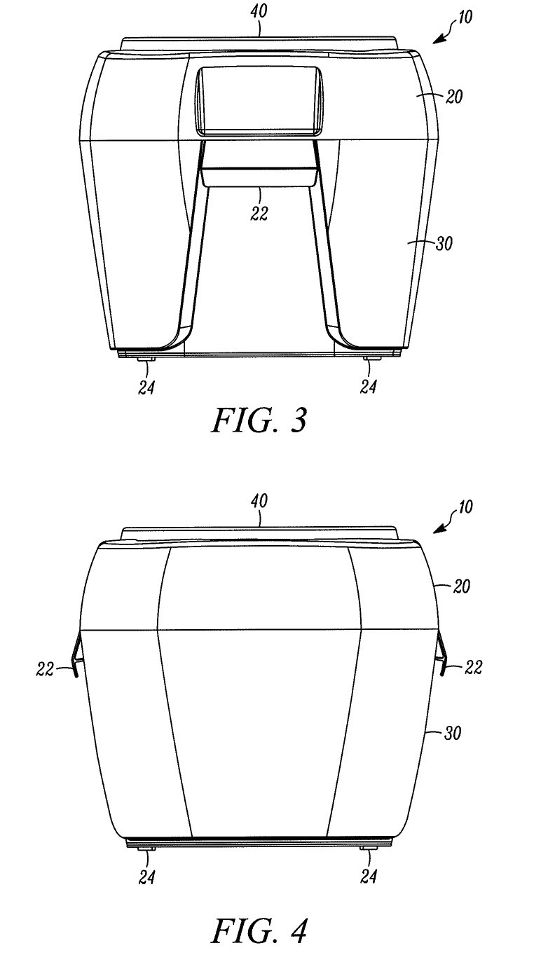

FIGS. 3 and 4 show varying side views of the dog food bowl 10 with the integrated food storage compartment 32. As can be seen in the figures, the base 30 and the cover 20 elevate a removable food or water container 40 off of the ground. Elevated dog food bowls are recommended for large dogs so they do not have to stoop to eat. Elevated dog food bowls aid in swallowing and digestion.

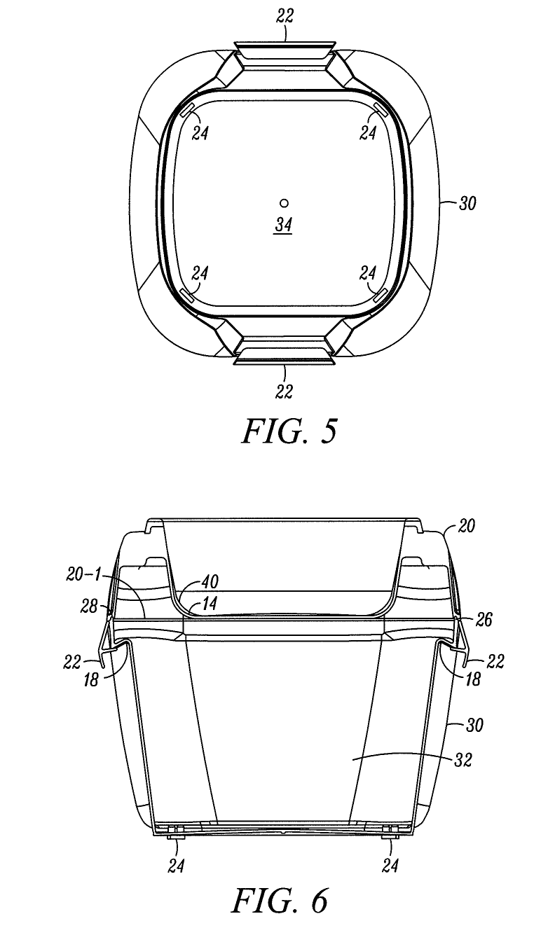

As can be seen from FIG. 5, non-skid rubber feet 24 can be affixed to or molded onto the bottom 34 of the base 30 to help prevent the base 30, cover 20, and container 40 from being pushed across the floor by a dog while he/she eats. The interior of the container 40 is hollow, and may retain a large quantity of dog food. The weight added by the dog food helps weigh down the elevated dog food bowl 10 and further helps to prevent the base 30, cover 20, and container 40 from being pushed.

As can be seen from FIG. 6, the container 40 sits within a depression 14 in the cover 20. When the container 40 is removed from the cover 20, the food storage compartment 32 in the base 30 remains fully enclosed by a planar member 20-1 formed in the cover 20, keeping the airtight seal intact. Depressions are formed within opposing sidewalls of the base 30 to form hand holds 18.

The top of the base 30 has a vertical protrusion 26 which interlocks with a depression 28 in the bottom of the cover 20. The vertical protrusion 26 and depression 28 combine within a tight tolerance, using a “tongue in groove” design to form an airtight seal. The outside edge of the vertical protrusion 26 is slightly angled in order to lead the vertical protrusion 26 into the depression 28 in the bottom of the cover 20.

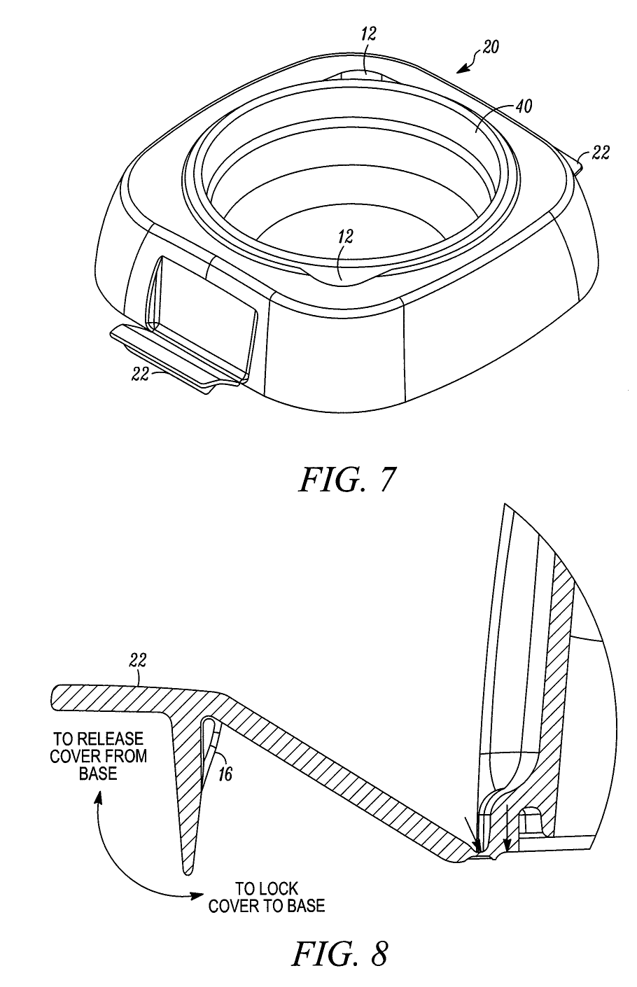

FIG. 7 shows the container 40 seated in the cover 20. The container 40 is preferably formed from stainless steel. Stainless steel dog food bowls are recommended by veterinarians since they do not harbor bacteria and are easy to clean.

FIG. 8 shows a close-up view of an exemplary latch 22. The sealing function provided by a mechanism such as a latch is used to further enhance the airtight seal and keep the dog food in the storage region 32 fresh. As the exemplary latch 22 is swung closed, a ramp-like feature 16 on the exemplary latch 22 engages the hand-hold 18 on the base 30 and draws the cover 20 down until it touches the base 30. This forcing of the cover 20 onto the base 30 ensures that the seal is airtight. Alternative forms of a sealing mechanism may include a rotatable latch, a twist lock mechanism, or interlocking threaded fasteners between the cover and the base.

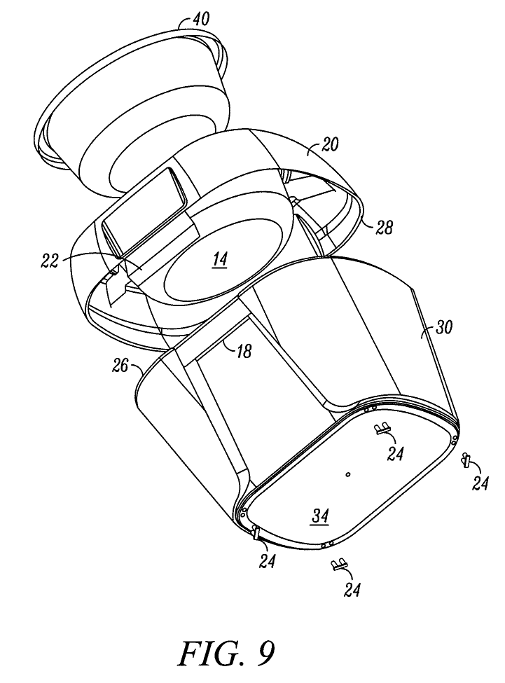

FIG. 9 shows one embodiment of the invention in which the base 30 and cover 20 are completely detachable from each other. In another embodiment of the invention, the cover 20 is connected by a hinge to the base 30 and the container 40 is removably attached to cover 20 while in the depression 14. This allows for the cover 20 to act as a cap for the base 30, while also preventing the container 40 from falling out when the cover 20 is opened.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

I claim:

1. An animal feeder assembly comprising:
a hollow base with an exterior bottom surface, an open top, and sidewalls, extending upward from the bottom surface to define a storage region;
a cover with a top surface, at least one depression formed in the top surface to receive at least one feeding bowl,
the cover having at least one sealing mechanism which releasably locks the cover to the base to provide an airtight seal between the cover and the base; and
the feeding bowl, when seated in the depression, is isolated from the storage region.

2. An animal feeder as in claim 1 wherein the base has non-skid feet affixed to or molded onto the bottom of the base.

3. An animal feeder as in claim 1 wherein the sidewalls are cylindrical.

4. An animal feeder as in claim 1 wherein the base includes a sloping sidewall such that the open top of the base is either greater or smaller in area than the bottom surface.

5. An animal feeder as in claim 1 wherein a plurality of depressions are formed within opposing sidewalls of the base to define hand holds.

6. An animal feeder as in claim 5 wherein the sealing mechanism locks with the hand holds to form an airtight seal.

7. An animal feeder as in claim 1 wherein the cover is connected to a sidewall on the base, such that the cover is able to freely rotate along the axis where the cover and sidewall interface.

8. An animal feeder as in claim 7 wherein the feeding bowl is removably attached to the depression within the cover.

9. An animal feeder assembly comprising:
a hollow base with an exterior bottom surface, an open top and sidewalls, extending upward from the bottom surface to define a storage region;
a cover with a top surface; and
the cover having at least one manually operable sealing mechanism which releasably locks the cover to the base to provide an airtight seal between the cover and the base.

10. An animal feeder as in claim 9 wherein the sealing mechanism includes at least one of a twist-lock mechanism, a threaded mechanism, or a rotatable latch.

11. An animal feeder as in claim 10 wherein the sealing mechanism comprises a fastener selected from a group which includes a latch, a tie, a clasp, a closure, a pin, a buckle, a screw, a threaded fastener and a button.

12. An animal feeder as in claim 10 wherein a plurality of depressions are formed within opposing sidewalls of the base to define hand holds.

13. An animal feeder as in claim 12 wherein the sealing mechanism releasably attaches to at least one of the hand holds.

14. An animal feeder assembly comprising:
a hollow base with an exterior bottom surface and an open top;
a cover which removably engages the top of the base, closing same; and
at least one movable latch member carried by one of the cover or the base, the latch member releasably engages the other of the base or the cover, to clamp the cover to the base forming an airtight seal there between.

15. An animal feeder as in claim 14 where the latch member is movable along one of a linear or a curved path.

16. An animal feeder as in claim 15 which includes a second latch member displaced from the one latch member.

17. An animal feeder as in claim 15 which includes at least one non-slip surface located adjacent to the exterior bottom surface.

18. An animal feeder as in claim 14 which includes a plurality of spaced-out non-slip surfaces formed adjacent to the bottom surface.

19. An animal feeder assembly comprising:
a hollow base with an exterior bottom surface and an open top;
a cover with a top surface, at least one depression formed in the top surface to receive at least one feeding bowl,
at least one sealing mechanism which releasably locks the cover to the base to provide an airtight seal between the cover and the base; and
the feeding bowl, when seated in the depression, is isolated from the storage region.

20. An animal feeder as in claim 19 wherein the cover is connected to a sidewall on the base, such that the cover is able to freely rotate along an axis where the cover and sidewall interface.

21. An animal feeder as in claim 20 wherein the feeding bowl is removably attached in the depression, to the cover.

22. An animal feeder as in claim 20 wherein the sealing mechanism comprises at least one of a rotatable latch, threads on the cover and base, and a twist lock latch between the cover and base.
